(19) United States
(12) Patent Application Publication
(10) Pub. No.: US 2023/0060261 A1
(43) Pub. Date: Mar. 2, 2023

(54) High Efficiency Isolation of Intersection and Road Crossings for Driving Analytics

(71) Applicant: STATE FARM MUTUAL AUTOMOBILE INSURANCE COMPANY, Bloomington, IL (US)

(72) Inventor: Alexander Gataric, Normal, IL (US)

(21) Appl. No.: 17/464,343

(22) Filed: Sep. 1, 2021

(51) Int. Cl. G08G 1/01; G08G 1/056

(52) U.S. Cl. CPC G08G 1/0112; G08G 1/056; G08G 1/012

(57) ABSTRACT

An example method includes obtaining raw telematics data from a vehicle trip; comparing bounding boxes associated with respective intersections to the raw telematics data points from the vehicle trip in order to isolate points that are within bounding boxes associated with intersections and validating that the raw telematics data points within a bounding box associated with an intersection are associated with an actual traversal of the intersection by comparing a line created by combining the raw telematics data points within the bounding box to a spatial average line for other trips through the intersection. For each intersection, an a determining, for each intersection, an average acceleration of the portion of the vehicle trip through the intersection may be compared to the average acceleration of trips through the intersection by other vehicles in order to determine a measure of safety associated with the portion of the vehicle trip through the intersection.

### FIELD OF THE DISCLOSURE

The present disclosure generally relates to vehicle telematics and, more particularly, to identifying and analyzing raw telematics data points from vehicle trips that are associated with particular intersections or road segments.

### BACKGROUND

Telematics is a method of monitoring a vehicle. By combining a location determination system (e.g., the global positioning system (GPS)) data with on-board monitoring data, it is possible to record and map where a vehicle is located, how fast the vehicle is traveling or a rate of acceleration associated with the vehicle, how the vehicle is being driven (e.g., directly, based on indications of driver operation such as application of brake or gas pedals, or indirectly, e.g., high acceleration values may correlate to poor driving behavior), and, in some examples, cross reference that information with how the vehicle is operating internally.

Analyzing telematics data can be processor intensive due to the volume of sensor data. Current driving analytics methods typically simplify telematics data prior to identifying whether the telematics data is associated with a particular location, such as an intersection, a road segment, etc. However, while simplifying telematics data, i.e., by reducing the total number of telematics data points, is intended to reduce the burden on processors, this simplification can itself be processor-intensive. Furthermore, because this simplifying is done prior to identifying a location associated with the telematics data, simplifying raw telematics data points can sometimes involve using processor time and resources to simplify telematics data that ultimately is not related to an intersection or a road segment of interest.

### SUMMARY

In an aspect, a computer-implemented method is provided, comprising: obtaining, by one or more processors, raw telematics data points associated with a vehicle trip; comparing, by the one or more processors, a bounding box representing an area associated with an intersection to the raw telematics data points associated with the vehicle trip in order to isolate any raw telematics data points associated with the vehicle trip that are within the bounding box representing the area associated with the intersection; determining, by the one or more processors, an average acceleration of a portion of the vehicle trip through the intersection based on the raw telematics data points associated with the vehicle trip that are within the bounding box representing the area associated with the intersection; and comparing, by the one or more processors, the average acceleration of the portion of the vehicle trip through the intersection to an aggregated average acceleration of other trips through the intersection by other vehicles in order to determine a measure of safety associated with the portion of the vehicle trip through the intersection.

In another aspect, a computer system is provided, comprising: one or more processors; and a non-transitory computer-readable memory coupled to the one or more processors and storing instructions thereon that, when executed by the one or more processors, cause the computer system to: obtain raw telematics data points associated with a vehicle trip; compare a bounding box representing an area associated with an intersections to the raw telematics data points associated with the vehicle trip in order to isolate any raw telematics data points associated with the vehicle trip that are within the bounding box representing the area associated with the intersection; determine an average acceleration of a portion of the vehicle trip through the intersection based on the raw telematics data points associated with the vehicle trip that are within the bounding box representing the area associated with the intersection; and compare the average acceleration of the portion of the vehicle trip through the intersection to an aggregated average acceleration of other trips through the intersection by other vehicles in order to determine a measure of safety associated with the portion of the vehicle trip through the intersection.

In still another aspect, a non-transitory computer-readable medium is provided, coupled to one or more processors and storing instructions thereon that, when executed by the one or more processors, cause the one or more processors to: obtain raw telematics data points associated with a vehicle trip; compare a bounding box representing an area associated with an intersection to the raw telematics data points associated with the vehicle trip in order to isolate any raw telematics data points associated with the vehicle trip that are within the bounding box representing the area associated with the intersection; determine an average acceleration of a portion of the vehicle trip through the intersection based on the raw telematics data points associated with the vehicle trip that are within the bounding box representing the area associated with the intersection; and compare the average acceleration of the portion of the vehicle trip through the intersection to an aggregated average acceleration of other trips through the intersection by other vehicles in order to determine a measure of safety associated with the portion of the vehicle trip through the intersection.

### BRIEF DESCRIPTION OF THE DRAWINGS

The figures described below depict various aspects of the systems and methods disclosed herein. Advantages will become more apparent to those skilled in the art from the following description of the embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive. Further, wherever possible, the following description refers to the reference numerals included in the following figures, in which features depicted in multiple figures are designated with consistent reference numerals.

FIG. 1 illustrates a block diagram of an example system for identifying and analyzing raw telematics data points from vehicle trips that are associated with particular intersections or road segments, in accordance with some embodiments.

FIG. 2A illustrates a visualization of raw telematics data points from vehicle trips that are associated with particular intersections, in accordance with some embodiments.

FIG. 2B illustrates a visualization of raw telematics data points from vehicle trips that are associated with particular road segments, in accordance with some embodiments.

FIG. 3 illustrates a flow diagram of an example method for identifying and analyzing raw telematics data points from vehicle trips that are associated with particular intersections or road segments, in accordance with some embodiments.

### DETAILED DESCRIPTION

As discussed above, analyzing telematics data can be processor intensive due to the volume of sensor data. Current driving analytics methods typically require a step of joining each telematics data point directly to a road definition, which can be very slow. Moreover, current driving analytics methods typically simplify telematics data prior to identifying whether the telematics data is associated with a particular location, such as an intersection, a road segment, etc. However, while simplifying telematics data, i.e., by reducing the total number of telematics data points, is intended to reduce the burden on processors, this simplification can itself be processor-intensive. Furthermore, because this simplifying is done prior to identifying a location associated with the telematics data, sometimes simplifying raw telematics data points can involve using processor time and resources to simplify telematics data that ultimately is not related to an intersection or a road segment of interest.

Generally speaking, the present disclosure allows for faster and less processor-intensive analysis of telematics data by using bounding boxes to identify which raw telematics data points are located in an area of interest, such as a particular intersection or road segment, prior to performing any kind of processing, simplification, or other analysis of the raw telematics data points.

A table of intersections and road segments is created in which each road is joined to two intersections, and it is assumed that a trip with two consecutive intersections drove over the defined road. The raw points are directly joined to a box shape (i.e., a bounding box) around the intersection. Using the intersection-road table, the points between the intersections are assumed to be on the defined road.

That is, a bounding-box-only spatial join, as used in the techniques provided by the present disclosure, is the fastest spatial type of spatial join, since it is the most simple and uses an index. Generally speaking, a bounding box is the box outline of a shape. A GiST index is created for the bounding box. First, the spatial index of the bounding box is compared to the spatial positions of each of the vehicle telematics data points to determine if the shape of the bounding box intersects with any of the vehicle telemetics data points. This process keeps spatial joins to a minimum which increases speed, i.e., compared to other methods that involve pinpointing where exactly the vehicle’s path intersects with a shape associated with the intersection. That is, comparing lines generated from driving data to spatial averages of driving data is much faster than joining individual data points to a road line, because the elements being joined are already identified by the bounding box join which minimizes computation.

Moreover, using the techniques of the present disclosure, road traversals are defined based on the time associated with each vehicle telematics data points, such that vehicle telematics data points that occur within the time range between two intersection traversals are defined as being associated with the traversal of a road segment that connects the two intersections. Generally speaking, the sequence of intersection crossings determines the direction associated with the traversal of a road. For instance, for vehicle telematics data points from a given trip that includes a traversal of a first intersection, and a subsequent second intersection that is east of the first intersection, vehicle telematics data points that temporally occur after the vehicle telematics data points associated with the traversal of the first intersection and before the vehicle telematics data points associated with the traversal of the second intersection can be defined as being associated with an Eastward traversal of a road segment that connects the first intersection and the second intersection.

Spatial averages of the road and intersections may then be used for validation, i.e., in order to determine whether a vehicle actually traversed a given intersection or road segment, e.g., as discussed in greater detail with respect to U.S. Pat. Application No. 17/188,767, titled “Systems and Methods of Collapse of Driving Data to Determine Spatial Averages of Vehicle Paths Within an Intersection,” the entirety of which is incorporated by reference herein. Aggregated acceleration values of individual road and intersection crossings are created which can be averaged per path and new drives can be compared to find outliers.

Specifically, the techniques of the present disclosure involve identifying raw driving telematics data points that were captured when a vehicle was located in a particular intersection by comparing the raw driving telematics data points to a bounding box representing the intersection. That is, if one or more raw driving telematics data points from a particular vehicle trip are within a bounding box representing a particular intersection, the particular vehicle trip may have included the particular intersection, and the raw driving telematics data points from the trip that are within the bounding box may be analyzed further, i.e., to validate that the trip did in fact include a traversal through the intersection, and to subsequently determine acceleration values (or braking values, or cornering values, or other relevant indicators of safety) associated with the vehicle’s traversal of the intersection during the validated trip. Similarly, the techniques of the present disclosure involve identifying raw driving telematics data points that were captured when a vehicle was located on a particular road segment by comparing the raw driving telematics data points to bounding boxes associated with intersections connected by the road segment. That is, if a particular road segment connects intersection A and intersection B, a vehicle trip including raw driving telematics data points in respective bounding boxes associated with intersection A and intersection B, and in the area between the respective bounding boxes associated with intersection A and intersection B, may include the road segment. Upon making this determination, the raw driving telematics data points from the trip that are in the area between the two bounding boxes may be analyzed further, i.e., to validate that the trip did in fact include a traversal over the road segment, and to subsequently determine acceleration values (or braking values, or cornering values, or other relevant indicators of safety) associated with the vehicle’s traversal of the road segment during the validated trip. The acceleration values for the trip’s raw driving telematics data points through the intersection or over the road segment may be compared to average acceleration values through the intersection or over the road segment in order to identify outliers, i.e., indicative of high risk behavior.

Thus, the techniques provided by the present disclosure may isolate both the points within an intersection and the roads that were driven on in a single step, before processing the raw driving telematics data points in any way, which ultimately results in a faster process with a lower processor burden.

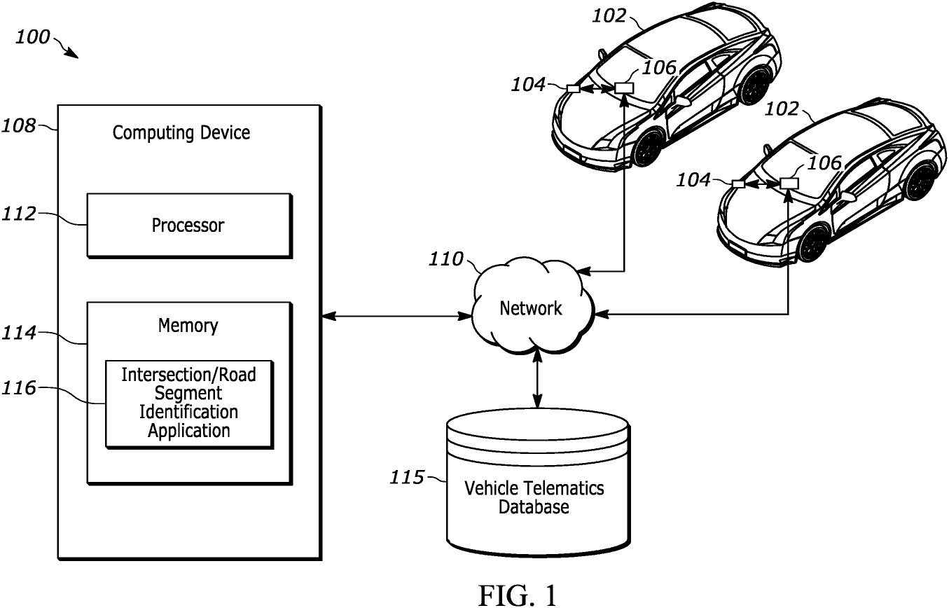

FIG. 1 illustrates a block diagram of an example system 100 for identifying and analyzing raw telematics data points from vehicle trips that are associated with particular intersections or road segments, in accordance with some embodiments. The high-level architecture illustrated in FIG. 1 may include both hardware and software applications, as well as various data communications channels for communicating data between the various hardware and software components, as is described below.

The system 100 may include a plurality of vehicles 102, each equipped with various sensors 104. The sensors 104 of each vehicle 102 may communicate, via a wired or wireless connection, with respective vehicle computing devices 106. In some examples, the vehicle computing devices 106 may be on-board computing devices. The vehicle computing devices 106 may communicate with another computing device 108, e.g., via signals sent over a network 110. For instance, the vehicle computing devices 106 may send telematics data or other measurements captured by the sensors 104 to the computing device 108 via the network 110.

The sensors 104 may include location sensors (e.g., GPS) and motion sensors (e.g., accelerometers, gyrometers, etc.) and other suitable vehicle telematics sensors configured to capture indications of the motion and operation of the respective vehicles 102 over time, as well as a clock function configured to timestamp various sensor readings and vehicle telematics data captured by the sensors 104.

The computing device 108 may include one or more processors 112 and a memory 114. The one or more processors 112 may interact with the memory 114 to obtain, for example, computer-readable instructions stored in the memory 114. The computer-readable instructions stored in the memory 114 may cause the one or more processors 112 to store telematics data sent by the vehicle computing device 106 in a vehicle telematics database 115, to access telematics data from the vehicle telematics database 115, and/or to execute one or more applications, such as intersection traversal determination application 116. The vehicle telematics database 115 may include telematics data from a plurality of vehicle trips made by a plurality of different vehicles 102.

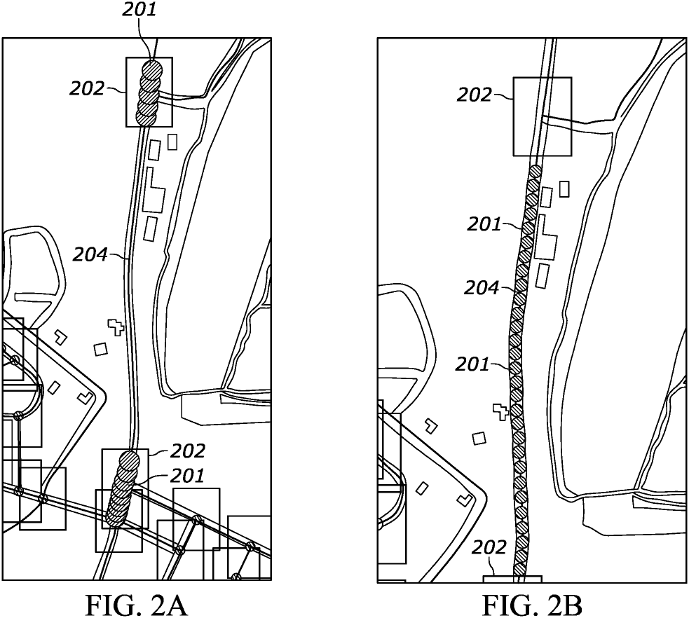

Executing the intersection and road segment identification application 116 may include determining an intersection or a road segment of interest based on input from a user, and obtaining raw telematics data points associated with a vehicle trip, e.g., from the vehicle telematics database 115. Furthermore, executing the intersection and road segment identification application 116 may include, for an intersection of interest, comparing a bounding box representing an area associated with the intersection of interest to the raw telematics data points associated with the vehicle trip in order to isolate any raw telematics data points associated with the vehicle trip that are within the bounding box representing the area associated with intersection of interest. For instance, FIG. 2A illustrates a visualization of raw telematics data points 201 from a vehicle trip that are located in bounding boxes 202 associated with intersections. That is, as shown in FIG. 2A, raw telematics data points 201 that are located in bounding boxes 202 are isolated, i.e., such that only raw telematics data points 201 that are located in intersections are shown and other raw telematics data points 201 from the same vehicle trip are not shown. While raw telematics data points 201 are shown in two bounding boxes 202 in FIG. 2A, generally speaking, one intersection of interest (and associated bounding box 202) may be selected, and only raw telematics data points 201 from that particular intersection 202 may be isolated for further analysis.

For a road segment of interest, executing the intersection and road segment identification application 116 may include identifying two intersections that the road segment of interest connects, i.e., including identifying bounding boxes associated with the two intersections, and if the vehicle trip includes raw telematics data points in both bounding boxes and in an area between the two bounding boxes, defining any raw telematics data points associated with the vehicle trip between the two bounding boxes as being associated with the road segment of interest, and isolating the raw telematics data points from the vehicle trip associated with the road segment of interest. For instance, FIG. 2B illustrates a visualization of raw telematics data points 201 from a vehicle trip that are associated with a road segment 204 between two intersections 202. That is, as shown in FIG. 2B, raw telematics data points 201 that are located along the road segment 204 are isolated for analysis, i.e., such that only raw telematics data points 201 that are located along the road segment 204 are shown and isolated for analysis, and other raw telematics data points 201 from the same vehicle trip (i.e., raw telematics data points from the vehicle trip that are located within intersections 202, or along other road segments) are not shown, and are not isolated for analysis.

Executing the intersection and road segment identification application 116 may include validating whether the isolated data points from the vehicle trip associated with each of the intersections and/or road segments traversed during the vehicle trip are associated with actual vehicle traversals of each respective intersection and/or road segment. The validation process may include first determining, for each possible intersection and/or road segment traversal, a direction of movement associated with the isolated data points from the vehicle trip associated with the intersection of interest or road segment of interest. Once the direction of traversal is determined, executing the intersection and road segment identification application 116 may include comparing the isolated data points from the vehicle trip associated with each intersection and/or road segment traversal to spatial averages of other vehicles traversing the same intersections and/or road segment in the same direction. In some examples, executing the intersection and road segment identification application 116 may include generating line by combining the isolated data points from the vehicle trip associated with each intersection and/or road segment traversal and, for each intersection and/or road segment traversal, comparing the line to a line representing the spatial average of other vehicles traversing the same intersection and/or road segment in the same direction.

Comparing the spatial average vehicle path for other vehicles that traversed the same intersection or road segment in the same direction may include determining a measure of the difference between the line representing the portion of the vehicle trip through the intersection or over the road segment and a line representing the spatial average path of turns associated with the same direction through the intersection or over the road segment made during other vehicle trips by other vehicles. In particular, the vehicle telematics data points representing the portion of the vehicle trip through the intersection or over the road segment may be combined into a line, which is then divided into a number of equal line segments. The line representing the spatial average path of turns associated with the same direction through the intersection or over the road segment made during other vehicle trips by other vehicles may also be divided into the same number of equal line segments, and a measure of difference between each line segment from the portion of the vehicle trip through the intersection or over the road segment and a corresponding line segment from the spatial average path may be calculated. If, collectively (i.e., based on all line segments) the measure of difference between the vehicle’s path through the intersection or over the road segment and the spatial average of other vehicles’ paths through the same intersection or over the same road segment in the same direction is less than a threshold measure of difference, the raw telematics data points associated with the vehicle trip that are within the bounding box representing the area associated with the intersection, or associated with the road segment connecting two subsequent intersections, may be validated as being associated with an actual vehicle traversal of the intersection or road segment.

In the case of an intersection of interest, executing the intersection and road segment identification application 116 may include calculating an average acceleration of a portion of the vehicle trip through the intersection based on the raw telematics data points associated with the vehicle trip that are within the bounding box representing the area associated with the intersection (in some cases, only for validated traversals of the intersection). Similarly, in the case of a road segment of interest, executing the intersection and road segment identification application 116 may include determining an average acceleration of a portion of the vehicle trip over the road segment based on the raw telematics data points from the vehicle trip associated with the road segment (in some cases, only for validated traversals of the road segment). Executing the intersection and road segment identification application 116 may further include determining average acceleration of the portion of the vehicle trip through the intersection of interest or the portion of the vehicle trip over the road segment of interest based on the raw telematics data points that are validated as being associated with the actual vehicle traversal of the intersection or road segment.

Moreover, in the case of an intersection of interest, executing the intersection and road segment identification application 116 may include comparing the average acceleration of the portion of the vehicle trip through the intersection of interest to an aggregated average acceleration of other trips through the intersection of interest by other vehicles in order to determine a measure of safety associated with the portion of the vehicle trip through the intersection of interest. Similarly, in the case of a road segment of interest, executing the intersection and road segment identification application 116 may include comparing the average acceleration of the portion of the vehicle trip over the road segment of interest to an aggregated average acceleration of other trips over the road segment by other vehicles in order to determine a measure of safety associated with the portion of the vehicle trip over the road segment. Specifically, the raw telematics data points from the portion of the vehicle trip through the intersection of interest or the portion of the vehicle trip over the road segment of interest may be aggregated to determine the average, minimum and maximum acceleration values (or speed values, or braking values, or cornering values, etc.) of the vehicle’s trip through the intersection of interest or over the road segment of interest. Executing the intersection and road segment identification application 116 may include comparing these values to the corresponding average values of vehicles traversing the intersection of interest or traveling over the road segment of interest to identify outliers who may be a higher risk. This comparison may be used to assess how the driver’s acceleration, speed, braking, cornering, etc., through the intersection or over the road segment during the vehicle trip compares to that of other drivers that have made the same turn, i.e., to determine whether the driver operated the vehicle more or less safely on average compared to other drivers during that vehicle trip. For example, drivers who operate their vehicles more safely on average compared to other drivers who make the same maneuvers may be eligible for discounts. In some examples, executing the intersection and road segment identification application 116 may include generating warnings, guidance, or other notifications to drivers who operate their vehicles less safely on average compared to other drivers who make the same maneuvers or travel over the same road segments.

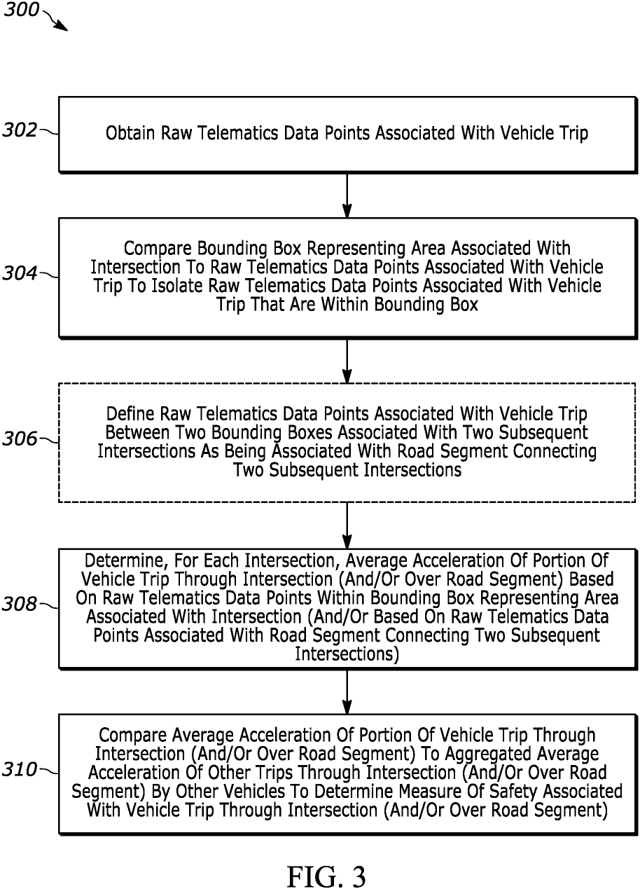

Furthermore, the computer-readable instructions stored on the memory 114 may include instructions for carrying out any of the steps of the method 300, described in greater detail below with respect to FIG. 3.

FIG. 3 illustrates a flow diagram of an example method 300 for identifying and analyzing raw telematics data points from vehicle trips that are associated with particular intersections or road segments, in accordance with some embodiments. One or more steps of the method 300 may be implemented as a set of instructions stored on a computer-readable memory 114 and executable on one or more processors 112.

The method 300 may begin when raw telematics data points associated with a vehicle trip are obtained (block 302).

The method 300 may further include comparing (block 304) a bounding box representing an area associated with an intersection to the raw telematics data points associated with the vehicle trip in order to isolate any raw telematics data points associated with the vehicle trip that are within the bounding box representing the area associated with the intersection. For instance, in some examples, the method 300 may include analyzing road map data in order to generate a plurality of bounding boxes representing areas associated with the plurality of respective intersections, including, e.g., where the bounding boxes should be located and the sizes of each of the bounding boxes. In other examples, the method 300 may include receiving input from users indicating where bounding boxes representing areas associated with each of the plurality of respective intersections should be located, the size of each bounding box, etc.

Additionally, the method 300 may optionally include defining (block 306), when the vehicle trip includes raw data points within two bounding boxes associated with two subsequent intersections, any raw telematics data points associated with the vehicle trip between the two bounding boxes as being associated with a road segment connecting the two subsequent intersections. In some examples, the method 300 may further include isolating the raw telematics data points from the vehicle trip associated with each respective road segment connecting two subsequent intersections.

In some examples, the method 300 may include validating whether the data points from the vehicle trip associated with an intersection, or associated with a road segment connecting two subsequent intersections, are associated with an actual vehicle traversal of the intersection or road segment. The validation process may include first determining, in the case of an intersection, a direction of movement associated with the raw telematics data points associated with the vehicle trip that are within the bounding box representing the area associated with the intersection, or, in the case of a road segment, determining a direction of movement associated with the raw telematics data points associated with a road segment connecting two subsequent intersections.

In some examples, determining the direction of movement through an intersection may include generating a line by combining the raw telematics data points from the vehicle’s trip that are within the bounding box associated with the intersection. Specifically, raw telematics data points associated with a particular vehicle that are within the bounding box associated with the intersection may be combined into a line ordered sequentially by time. Gaps in time between telematics data points associated with a particular vehicle that are within a bounding box associated with a given intersection may indicate that the same vehicle made multiple separate trips through the intersection. Accordingly, when there is gap in time that is greater than a threshold period of time between a first and second sequential vehicle telematics data point within the same bounding box, the first data point may be combined previous telematics data points to create a first line associated with a first traversal of the intersection while the second data point may be combined with subsequent telematics data points to create a second line associated with a second traversal of the intersection.

For each traversal of the intersection, the corresponding line may then be substringed into two segments: an entrance segment may be created as a line from the start of the line within the “cut” to the point that is 30% of the linear fraction of the length of the line within the “cut,” and an exit segment is created as a line from the 70% fraction of the length of the line within the “cut” to the end of the line within the “cut.” An angle measurement from 0 to 360 may then be determined for both the entrance segment and the exit segment. The direction of the vehicle’s turn through the intersection may then be determined based on these two angle measurements.

Determining the direction of movement over a road segment may be based on time stamp data and location data associated with each of the raw telematics data points determined to be associated with traversal of the road segment. That is, if a first chronological raw telematics data point is associated with a first location, if second and third chronological raw telematics data points are associated with respective second and third locations that continue to move in a particular direction (e.g., North, South, East, West, or any angular direction from 0 to 360), then that direction may be determined to be the direction of movement over the road segment.

Once the direction of traversal is determined, raw telematics data points that are within the bounding box representing the area associated with the intersection, or, in the case of the road segment, the raw telematics data points that are associated with the road segment, may be compared to spatial averages of other vehicles traversing the same intersection or road segment in the same direction. In some examples, a line generated by combining the raw telematics data points that are within the bounding box representing the area associated with the intersection, or, in the case of the road segment, a line generated by combining the raw telematics data points that are associated with the road segment, may be compared to a line representing the spatial average of other vehicles traversing the same intersection or road segment in the same direction.

Comparing the spatial average vehicle path for other vehicles that traversed the same intersection or road segment in the same direction may include determining a measure of the difference between the line representative of the portion of the vehicle trip through the intersection or over the road segment and the spatial average path of turns associated with the same direction through the intersection or over the road segment made during other vehicle trips by other vehicles. In particular, the vehicle telematics data points representing the portion of the vehicle trip through the intersection or over the road segment may be combined into a line, which is then divided into a number of equal line segments. The line representing the spatial average path of turns associated with the same direction through the intersection or over the road segment made during other vehicle trips by other vehicles may also be divided into the same number of equal line segments, and a measure of difference between each line segment from the portion of the vehicle trip through the intersection or over the road segment and a corresponding line segment from the spatial average path may be calculated. In some examples, calculating this measure of difference includes calculating a Hausdorff distance or a Frechet distance between the two lines. Generally speaking, a Hausdorff distance, or Hausdorff metric, also called Pompeiu-Hausdorff distance, measures how far two subsets of a metric space are from each other, and a Frechet distance is a measure of similarity between curves that takes into account the location and ordering of the points along the curves. If, collectively (i.e., based on all line segments) the measure of difference between the vehicle’s path through the intersection or over the road segment and the spatial average of other vehicles’ paths through the same intersection or over the same road segment in the same direction is less than a threshold measure of difference, the raw telematics data points associated with the vehicle trip that are within the bounding box representing the area associated with the intersection, or associated with the road segment connecting two subsequent intersections, may be validated as being associated with an actual vehicle traversal of the intersection or road segment.

Moreover, in some examples, comparing the spatial average vehicle path for other vehicles that traversed the same intersection or route segment in the same direction may reveal whether there are any discrepancies or deviations between the particular vehicle’s spatial path through the intersection or over the road segment and the average spatial path through the intersection or over the road segment. For instance, in some examples, a discrepancy or deviation (i.e., as determined based on a measure of difference greater than a threshold measure of difference) may indicate that the vehicle did not actually turn through the intersection or did not actually traverse the entire road segment. For example, the vehicle may have made a U-turn through the intersection rather than turning through the intersection, or may have made a U-turn rather than fully traversing the road segment. As another example, the vehicle may have turned into a parking lot near the intersection or partway through the road segment. Moreover, in some examples, a discrepancy or deviation may indicate that the vehicle may be driving unsafely or erratically through the intersection or over the road segment.

If the measure of difference between the vehicle’s path through the intersection or over the road segment and the spatial average of other vehicles’ paths through the same intersection or over the same road segment in the same direction is less than a threshold measure of difference, the raw telematics data points associated with the vehicle trip that are within the bounding box representing the area associated with the intersection, or associated with the road segment connecting two subsequent intersections, may be validated as being associated with an actual vehicle traversal of the intersection or road segment.

In any case, the method 300 may include determining (block 308), for a given intersection or for each intersection, an average acceleration of a portion of the vehicle trip through the intersection based on the raw telematics data points associated with the vehicle trip that are within the bounding box representing the area associated with the intersection (in some cases, only for validated traversals of the intersection). Similarly, the method may include determining, for a given road segment or for each road segment, an average acceleration of a portion of the vehicle trip over the road segment based on the raw telematics data points from the vehicle trip associated with the road segment (in some cases, only for validated traversals of the road segment). An average acceleration of the portion of the vehicle trip through the intersection or the portion of the vehicle trip over the road segment may then be determined based on the raw telematics data points that are validated as being associated with the actual vehicle traversal of the intersection or road segment.

Moreover, the method 300 may include comparing (block 310), for a given intersection or for each intersection, the average acceleration of the portion of the vehicle trip through the intersection to an aggregated average acceleration of other trips through the intersection by other vehicles in order to determine a measure of safety associated with the portion of the vehicle trip through the intersection. Similarly, the method 300 may include comparing, for a given road segment or for each road segment, the average acceleration of the portion of the vehicle trip over the road segment to an aggregated average acceleration of other trips over the road segment by other vehicles in order to determine a measure of safety associated with the portion of the vehicle trip over the road segment. Specifically, the raw telematics data points from the portion of the vehicle trip through the intersection or the portion of the vehicle trip over the road segment may be aggregated to determine the average, minimum and maximum acceleration values (or speed values, or braking values, or cornering values, etc.) of the vehicle’s trip through the intersection or over the road segment. These values may be compared to the corresponding average values of vehicles making that turn or traveling over that road segment to identify outliers who may be a higher risk. This comparison may be used to assess how the driver’s acceleration, speed, braking, cornering, etc., through the intersection or over the road segment during the vehicle trip compares to that of other drivers that have made the same turn, i.e., to determine whether the driver operated the vehicle more or less safely on average compared to other drivers during that vehicle trip. For example, drivers who operate their vehicles more safely on average compared to other drivers who make the same maneuvers may be eligible for discounts. In some examples, the method 300 may include generating warnings, guidance, or other notifications to drivers who operate their vehicles less safely on average compared to other drivers who make the same maneuvers.

With the foregoing, an insurance customer may opt-in to a rewards, insurance discount, or other type of program. After the insurance customer provides their affirmative consent, an insurance provider remote server may collect data from the customer’s mobile device or other smart devices - such as with the customer’s permission or affirmative consent. The data collected may be related to insured assets before (and/or after) an insurance-related event, including those events discussed elsewhere herein. In return, risk averse insureds may receive discounts or insurance cost savings related to home, renters, personal articles, auto, and other types of insurance from the insurance provider.

In one aspect, data, including the types of data discussed elsewhere herein, may be collected or received by an insurance provider remote server, such as via direct or indirect wireless communication or data transmission from a mobile device, or other customer computing device, after a customer affirmatively consents or otherwise opts-in to an insurance discount, reward, or other program. The insurance provider may then analyze the data received with the customer’s permission to provide benefits to the customer. As a result, risk averse customers may receive insurance discounts or other insurance cost savings based upon data that reflects low risk behavior and/or technology that mitigates or prevents risk to (i) insured assets, such as homes, personal belongings, or vehicles, and/or (ii) home or apartment occupants.

Although the foregoing text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within an office environment, or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer-implemented method, comprising:
obtaining, by one or more processors, raw telematics data points associated with a vehicle trip;
comparing, by the one or more processors, a bounding box representing an area associated with an intersection to the raw telematics data points associated with the vehicle trip in order to isolate any raw telematics data points associated with the vehicle trip that are within the bounding box representing the area associated with the intersection;
determining, by the one or more processors, an average acceleration of a portion of the vehicle trip through the intersection based on the raw telematics data points associated with the vehicle trip that are within the bounding box representing the area associated with the intersection; and
comparing, by the one or more processors, for the intersection, the average acceleration of the portion of the vehicle trip through the intersection to an aggregated average acceleration of other trips through the intersection by other vehicles in order to determine a measure of safety associated with the portion of the vehicle trip through the intersection.

2. The method of claim 1, wherein determining the average acceleration of the portion of the vehicle trip through the intersection based on the raw telematics data points associated with the vehicle trip that are within the bounding box representing the area associated with the intersection includes:
determining, by the one or more processors, a direction of movement associated with the raw telematics data points associated with the vehicle trip that are within the bounding box representing the area associated with the intersection;
comparing, by the one or more processors, the raw telematics data points associated with the vehicle trip that are within the bounding box representing the area associated with the intersection to a spatial average of portions of other vehicle trips through the intersection having the same determined direction of movement;
validating, by the one or more processors, based on the comparison, that the raw telematics data points associated with the vehicle trip that are within the bounding box representing the area associated with the intersection are associated with an actual vehicle traversal of the intersection; and
determining, by the one or more processors, the average acceleration of the portion of the vehicle trip through the intersection based on the raw telematics data points associated with the vehicle trip that are validated as being associated with the actual vehicle traversal of the intersection.

3. The computer-implemented method of claim 1, further comprising:
when the vehicle trip includes raw data points within two bounding boxes associated with two subsequent intersections, defining, by the one or more processors, any raw telematics data points associated with the vehicle trip between the two bounding boxes as being associated with a road segment connecting the two subsequent intersections.

4. The computer-implemented method of claim 3, further comprising:
isolating, by the one or more processors, the raw telematics data points from the vehicle trip associated with the road segment;
determining, by the one or more processors, for the road segment, an average acceleration of a portion of the vehicle trip over the road segment based on the raw telematics data points from the vehicle trip associated with the road segment; and
comparing, by the one or more processors, for the road segment, the average acceleration of the portion of the vehicle trip over the road segment to an aggregated average acceleration of other trips over the road segment by other vehicles in order to determine a measure of safety associated with the portion of the vehicle trip over the road segment.

5. The computer-implemented method of claim 4, wherein determining the average acceleration of the portion of the vehicle trip over the road segment based on the raw telematics data points associated with the road segment includes:
determining, by the one or more processors, a direction of movement associated with the raw telematics data points associated with the vehicle trip that are associated with the road segment;
comparing, by the one or more processors, the raw telematics data points associated with the vehicle trip that are associated with the road segment to a spatial average of portions of other vehicle trips over the road segment having the same determined direction of movement;
validating, by the one or more processors, based on the comparison, that the raw telematics data points associated with the road segment that are associated with an actual vehicle traversal of the road segment; and
determining, by the one or more processors, the average acceleration of the portion of the vehicle trip over the road segment based on the raw telematics data points associated with the vehicle trip that are validated as being associated with the actual vehicle traversal of the road segment.

6. The method of claim 1, further comprising:
analyzing, by the one or more processors, road map data in order to generate the plurality of bounding boxes representing areas associated with the plurality of respective intersections.

7. The method of claim 1, further comprising:
receiving, by the one or more processors, input from a user indicating the plurality of bounding boxes representing areas associated with the plurality of respective intersections.

8. A computer system, comprising:
one or more processors; and
a non-transitory computer-readable memory coupled to the one or more processors and storing instructions thereon that, when executed by the one or more processors, cause the computer system to:
obtain raw telematics data points associated with a vehicle trip;
compare a bounding box representing an area associated with an intersection to the raw telematics data points associated with the vehicle trip in order to isolate any raw telematics data points associated with the vehicle trip that are within the bounding box representing the area associated with the intersection;
determine an average acceleration of a portion of the vehicle trip through the intersection based on the raw telematics data points associated with the vehicle trip that are within the bounding box representing the area associated with the intersection; and
compare the average acceleration of the portion of the vehicle trip through the intersection to an aggregated average acceleration of other trips through the intersection by other vehicles in order to determine a measure of safety associated with the portion of the vehicle trip through the intersection.

9. The computer system of claim 8, wherein the instructions cause the computer system to determine the average acceleration of the portion of the vehicle trip through the intersection based on the raw telematics data points associated with the vehicle trip that are within the bounding box representing the area associated with the intersection by:
determining a direction of movement associated with the raw telematics data points associated with the vehicle trip that are within the bounding box representing the area associated with the intersection;
comparing the raw telematics data points associated with the vehicle trip that are within the bounding box representing the area associated with the intersection to a spatial average of portions of other vehicle trips through the intersection having the same determined direction of movement;
validating, based on the comparison, that the raw telematics data points associated with the vehicle trip that are within the bounding box representing the area associated with the intersection are associated with an actual vehicle traversal of the intersection; and
determining the average acceleration of the portion of the vehicle trip through the intersection based on the raw telematics data points associated with the vehicle trip that are validated as being associated with the actual vehicle traversal of the intersection.

10. The computer system of claim 8, wherein the instructions further cause the computer system to:
when the vehicle trip includes raw data points within two bounding boxes associated with two subsequent intersections, define any raw telematics data points associated with the vehicle trip between the two bounding boxes as being associated with a road segment connecting the two subsequent intersections.

11. The computer system of claim 10, wherein the instructions further cause the computer system to:
isolate the raw telematics data points from the vehicle trip associated with the road segment;
determine, for the road segment, an average acceleration of a portion of the vehicle trip over the road segment based on the raw telematics data points from the vehicle trip associated with the road segment; and
compare, for the road segment, the average acceleration of the portion of the vehicle trip over the road segment to an aggregated average acceleration of other trips over the road segment by other vehicles in order to determine a measure of safety associated with the portion of the vehicle trip over the road segment.

12. The computer system of claim 11, wherein the instructions cause the computer system to determine the average acceleration of the portion of the vehicle trip over the road segment based on the raw telematics data points associated with the road segment by:
determining a direction of movement associated with the raw telematics data points associated with the vehicle trip that are associated with the road segment;
comparing the raw telematics data points associated with the vehicle trip that are associated with the road segment to a spatial average of portions of other vehicle trips over the road segment having the same determined direction of movement;
validating, based on the comparison, that the raw telematics data points associated with the road segment that are associated with an actual vehicle traversal of the road segment; and
determining the average acceleration of the portion of the vehicle trip over the road segment based on the raw telematics data points associated with the vehicle trip that are validated as being associated with the actual vehicle traversal of the road segment.

13. The computer system of claim 8, wherein the instructions further cause the computer system to:
analyze road map data in order to generate the plurality of bounding boxes representing areas associated with the plurality of respective intersections.

14. The computer system of claim 8, wherein the instructions further cause the computer system to:
receive input from a user indicating the plurality of bounding boxes representing areas associated with the plurality of respective intersections.

15. A non-transitory computer-readable medium coupled to one or more processors and storing instructions thereon that, when executed by the one or more processors, cause the one or more processors to:
obtain raw telematics data points associated with a vehicle trip;
compare a bounding box representing an area associated with an intersection to the raw telematics data points associated with the vehicle trip in order to isolate any raw telematics data points associated with the vehicle trip that are within the bounding box representing the area associated with the intersection;
determine an average acceleration of a portion of the vehicle trip through the intersection based on the raw telematics data points associated with the vehicle trip that are within the bounding box representing the area associated with the intersection; and
compare the average acceleration of the portion of the vehicle trip through the intersection to an aggregated average acceleration of other trips through the intersection by other vehicles in order to determine a measure of safety associated with the portion of the vehicle trip through the intersection.

16. The non-transitory computer-readable medium of claim 15, wherein the instructions cause the one or more processors to determine the average acceleration of the portion of the vehicle trip through the intersection based on the raw telematics data points associated with the vehicle trip that are within the bounding box representing the area associated with the intersection by:
determining a direction of movement associated with the raw telematics data points associated with the vehicle trip that are within the bounding box representing the area associated with the intersection;
comparing the raw telematics data points associated with the vehicle trip that are within the bounding box representing the area associated with the intersection to a spatial average of portions of other vehicle trips through the intersection having the same determined direction of movement;
validating, based on the comparison, that the raw telematics data points associated with the vehicle trip that are within the bounding box representing the area associated with the intersection are associated with an actual vehicle traversal of the intersection; and
determining the average acceleration of the portion of the vehicle trip through the intersection based on the raw telematics data points associated with the vehicle trip that are validated as being associated with the actual vehicle traversal of the intersection.

17. The non-transitory computer-readable medium of claim 15, wherein the instructions further cause the one or more processors to:
when the vehicle trip includes raw data points within two bounding boxes associated with two subsequent intersections, define any raw telematics data points associated with the vehicle trip between the two bounding boxes as being associated with a road segment connecting the two subsequent intersections.

18. The non-transitory computer-readable medium of claim 17, wherein the instructions further cause the one or more processors to:
isolate the raw telematics data points from the vehicle trip associated with the road segment;
determine an average acceleration of a portion of the vehicle trip over the road segment based on the raw telematics data points from the vehicle trip associated with the road segment; and
compare the average acceleration of the portion of the vehicle trip over the road segment to an aggregated average acceleration of other trips over the road segment by other vehicles in order to determine a measure of safety associated with the portion of the vehicle trip over the road segment.

19. The non-transitory computer-readable medium of claim 17, wherein the instructions cause the one or more processors to determine the average acceleration of the portion of the vehicle trip over the road segment based on the raw telematics data points associated with the road segment by:
determining a direction of movement associated with the raw telematics data points associated with the vehicle trip that are associated with the road segment;
comparing the raw telematics data points associated with the vehicle trip that are associated with the road segment to a spatial average of portions of other vehicle trips over the road segment having the same determined direction of movement;
validating, based on the comparison, that the raw telematics data points associated with the road segment that are associated with an actual vehicle traversal of the road segment; and
determining the average acceleration of the portion of the vehicle trip over the road segment based on the raw telematics data points associated with the vehicle trip that are validated as being associated with the actual vehicle traversal of the road segment.

20. The non-transitory computer-readable medium of claim 15, wherein the instructions further cause the one or more processors to:
analyze road map data in order to generate the plurality of bounding boxes representing areas associated with the plurality of respective intersections.
